(19) United States
(12) Patent Application Publication
(10) Pub. No.: US 2015/0301858 A1
(43) Pub. Date: Oct. 22, 2015

(54) MULTIPROCESSORS SYSTEMS AND PROCESSES SCHEDULING METHODS THEREOF

(71) Applicant: NATIONAL TSING HUA UNIVERSITY, Hsinchu (TW)

(72) Inventors: Yeh-Ching CHUNG, Hsinchu (TW); Wei-Chih SUN, Hsinchu (TW)

(21) Appl. No.: 14/606,993

(22) Filed: Jan. 27, 2015

(30) Foreign Application Priority Data
Apr. 21, 2014 (TW) 103114349

(51) Int. Cl. G06F 9/48

(52) U.S. Cl. CPC G06F 9/4818; G06F 9/4893

(57) ABSTRACT

Scheduling methods for a multi-core processor system including multiple processors are provided. First, a process to be executed is chosen from a ready queue and analyzed to obtain a power consumption value of the process to be executed. Next, an idle processor is chosen from the processors and a total power consumption value of system through which the process to be executed is being executed in the idle processor is estimated to obtain a first prediction result based on the obtained power consumption value. It is then determined whether to execute the process to be executed in the idle processor according to the first predicted value and a predetermined upper limit value. In some embodiments, the scheduling method may further provide preemption scheduling such that the process with high priority can be preferentially executed and process can flexible switch among different processor core clusters.

### CROSS REFERENCE TO RELATED APPLICATIONS

This application claims the benefit of Taiwan Patent Application No. 103114349, filed Apr. 21, 2014, the entirety of which is incorporated by reference herein.

### BACKGROUND OF THE INVENTION

1. Field of the Invention

The disclosure relates generally to scheduling methods of processor systems and, more particularly to scheduling method for a multi-core processor system with a plurality of processors.

2. Description of the Related Art

As user demand for performance increases, more and more electronic devices contain multiple processors or multi-core processors in which multi-core processor system can combine processing cores with different abilities or different sizes together. ARM has proposed a big.LITTLE architecture for multi-core processor system. The concept of the big.LITTLE architecture is to combine the processors (CPU) with a number of processors with higher clock known as big and a number of processors with lower clock known as little, wherein a large-core processor (big CPU) has strong performance and thus consume more power, while a small-core processor (little CPU) has poor performance than the big CPU, and thus save more power than the big CPU.

Currently, scheduling methods (Scheduling) implemented in the big.LITTLE architecture only have two cases: either all are large-core processor or all are small-core processor. Another scheduling method is mainly determined based on the Dynamic Voltage Frequency Scaling (DVFS). However, both methods cannot be switched elastically among different types of core clusters.

### BRIEF SUMMARY OF THE INVENTION

Multi-core processor systems and scheduling methods using the same are provided.

In an embodiment of a scheduling method for a multi-core processor system including multiple processors is provided. First, a process to be executed is chosen from a ready queue and analyzed to obtain a power consumption value of the process to be executed. Next, an idle processor is chosen from the processors and a total power consumption value of system through which the process to be executed is being executed in the idle processor is estimated to obtain a first prediction result based on the obtained power consumption value. It is then determined whether to execute the process to be executed in the idle processor according to the first prediction result and a predetermined upper limit value, wherein the process to be executed is determined to be executed in the idle processor when the first prediction result is smaller than the predetermined upper limit value.

An embodiment of a multi-core processor system includes a storage unit, a plurality of processors and a scheduling unit. The scheduling unit is coupled to the storage unit and the plurality of processors. The scheduling unit is arranged for choosing a process to be executed from a ready queue, analyzing the process to be executed to obtain a power consumption value of the process to be executed, choosing an idle processor from the plurality of processors and estimating a total power consumption value of system when the process to be executed is being executed in the idle processor to obtain a first prediction result based on the obtained power consumption value of the process to be executed, and determining whether to execute the process to be executed in the idle processor according to the first prediction result and a predetermined upper limit value, wherein the scheduling unit determines that the process to be executed is executed in the idle processor when the first prediction result is smaller than the predetermined upper limit value.

Scheduling methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a multi-core processor system of the invention;

FIG. 2 is a flowchart of an embodiment of a scheduling method of the invention;

FIG. 3 is a flowchart of another embodiment of a scheduling method of the invention;

FIG. 4 is a flowchart of yet another embodiment of a scheduling method of the invention; and

FIG. 5 is a flowchart of still another embodiment of a scheduling method of the invention.

### DETAILED DESCRIPTION OF THE INVENTION

The following description shows several exemplary embodiments which carry out the invention. This description is made for the purpose of illustrating the general principles of the invention and should not be taken in a limiting sense. The scope of the invention is best determined by reference to the appended claims.

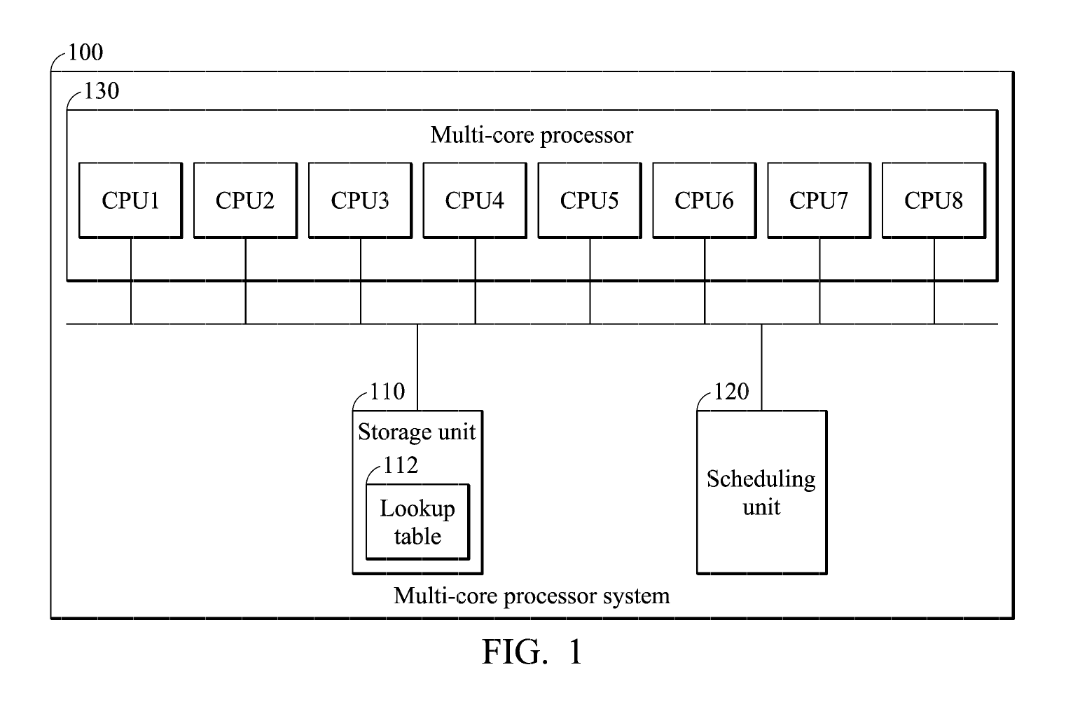

The invention will now be described with reference to FIGS. 1 through 5, which generally relate to process scheduling methods capable of keeping constant energy consumption and maintaining a certain level of operation performance for processors and related processor systems using a big.LITTLE architecture. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

Embodiments of the present invention provide multi-core processor systems and related process scheduling methods capable of keeping constant energy consumption and maintaining a certain level of operation performance for processors and related processor systems using the big.LITTLE architecture, which can use the power consumption value of the whole system as a transfer or switch index between big core clusters and list core clusters so as to in terms of balance between high performance and low energy consumption.

FIG. 1 is a schematic diagram illustrating an embodiment of a multi-core processor system of the invention. The multi-core processor system 100 at least comprises a storage unit 110, a scheduling unit 120 and a multi-core processor 130. The multi-core processor system 100 can be applied to any electronic device with multi-core processors or central processing units (CPUs) architecture, such as a smartphone, a PDA (Personal Digital Assistant), a mobile internet device, a laptop computer, a tablet computer or other similar mobile computing device, but it is not limited thereto. The storage unit 110 may be a built-in memory, or an external memory card, which stores related data, such as a lookup table 112 which shows a record of information of power consumption values required by the processes as well as information of the current total power consumption values of the system. In particular, the information of the current total power consumption values of the system is used to indicate the total power consumption values of the processes in the processors being executed, which can be obtained by adding up the power consumption value of each process. Additionally, the lookup table 112 may also contain information related to the processes (not shown), such as the size, type, priority and so on of each process. The scheduling unit 120 may refer to given information in process management and scheduling. The scheduling unit 120 can also be used to execute the process scheduling of different processing cores or between processors and determine switching between clusters in different core processors. The multi-core processor 130 includes multiple processing cores, and the makeup of these processing cores is based on the concept of big.LITTLE. The concept of big.LITTLE refers to the combination of processing cores with different capacities or specifications. For example, they may be made up of multiple CPUs with higher clock known as big core CPUs and multiple CPUs with lower clock known as little core CPU. The big core may contain logic element configuration unlike that of the little core. The big core consumes more power due to a higher performance, while the little core saves more power but with less performance. Therefore, it can be applied to software or processes that switch between two cores so as to save the overall power consumption value for devices stated in the standby mode most of the time under general applications. For example, in one embodiment, the multi-core processor 130 may contain eight processing cores, four of which are big cores with optimized performance and the other four are processing cores with optimized low power consumption values in standby mode and the invention is not limited thereto. In this embodiment, the multi-core processor 130 contains multiple processors, each containing one or multiple cores. The processors can be divided into big core processor clusters and little core processor clusters. As shown in FIG. 1, the multi-core processor 130 includes CPU1-CPU8, of which CPU1-CPU4 have big cores and thus fall under the big core processor cluster; CPU5-CPU8 have little cores and thus fall under the little core processor cluster.

The scheduling unit 120 (such as OS scheduler) is coupled to the storage unit 110 and multiple processing cores, which can be used to perform the scheduling method of the present invention for scheduling in the processes of the ready queue, which will be discussed further in the following paragraphs.

To be more specific, before the multi-core processor 130 is switched from one process to the other, OS must retain its original process execution state. At the same time, a new process execution state must be uploaded. This is known as context switching or switching for short. In particular, the ready queue includes all processes to be executed. Additionally, before all the processes receive the control of the multi-core processor 130, they must wait for the scheduling unit 120 for scheduling in the ready queue. The scheduling unit 120 chooses one suitable process from the ready queue for execution in one of the processing cores or returns processes being executed to the ready queue for scheduling. In the following embodiments, when one process is switched from one process core (such as the little core) to the other processing core (such as the big core) for execution, the aforementioned context switching will be executed. In another embodiment, the multi-core processor 130 can be a single processor that contains multiple processing cores, and these multiple processing cores can be divided into big core processor clusters and little core processor clusters. Hence, the scheduling method mentioned can also be used for scheduling.

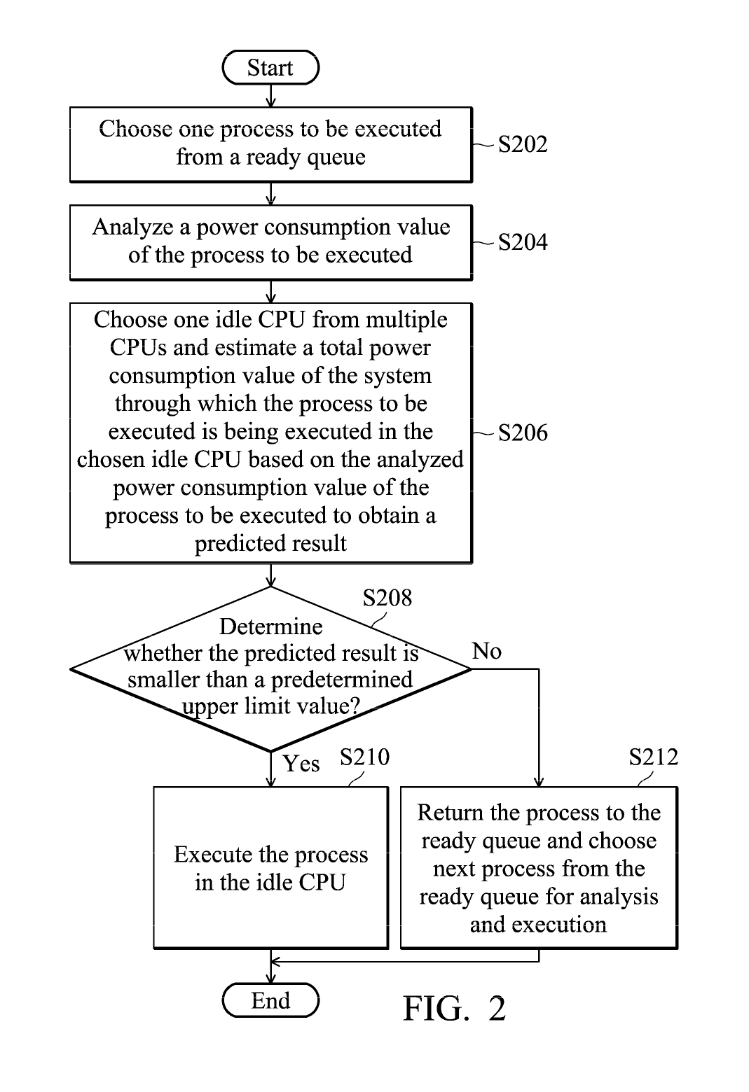

FIG. 2 is a flowchart of an embodiment of a scheduling method of the invention. The scheduling method can be used for an electronic device with multiple processing cores, such as a PDA, a smart phone, a mobile phone, a mobile internet device, a laptop computer, a tablet computer or other similar mobile computing device. For example, the scheduling method can be performed by the scheduling unit 120 of the electronic device 100 shown in FIG. 1. In this embodiment, assuming the electronic device 100 contains eight processing cores and that four of the processing cores fall under the big core cluster, the remaining four fall under the little core cluster.

First, in step S202, one process to be executed is first chosen from the ready queue. Then, in step S204, the power consumption value of the process to be executed is analyzed. For example, the lookup table 112 can be used as the basis for analyzing the power consumption value of the corresponding process to be executed.

Thereafter, in step S206, one idle CPU from the multiple processors is chosen and a total power consumption value of the system through which the process to be executed is being executed in the chosen idle CPU is estimated based on the analyzed power consumption value of the process to be executed to obtain a predicted result. The total power consumption value mentioned here refers to the sum of the system's current total power consumption value and the power consumption value of which the process chosen to be executed is being in the idle CPU. For example, assuming processor CPU1 is in the idle state, the power consumption value corresponding to the process to be executed as recorded in the lookup table 112 and the system's predetermined total power consumption value shall serve as the basis for estimating the total power consumption value of the process to be executed in CPU1 so as to obtain the predicted result.

After the total power consumption value of the system is estimated, in step S208, whether the predicted result is smaller than a predetermined upper limit value is further determined. In particular, the predicted result represents the system's total power consumption value mentioned above. When the predicted result is smaller than the predetermined upper limit value (Yes in step S208), it means the system's total power consumption value for executing the process in the idle CPU does not exceed the upper limit. Therefore, in step S210, it is determined that the process is executed in the idle CPU or the process is switched to the idle CPU for execution.

On the contrary, when the predicted result is greater or equal to the predetermined upper limit value (No in step S208), in step S212, it shows the system's total power consumption value when executing the process in the idle CPU has exceeded the upper limit. Hence, the process is returned to the ready queue to wait for subsequent scheduling, while one next process in the ready queue is chosen for analysis and execution.

In some embodiments, the present invention further provides methods for adaptively increasing the execution frequency of processor and preemption scheduling such that the process with high priority or timelines in the ready queue can be preferentially executed.

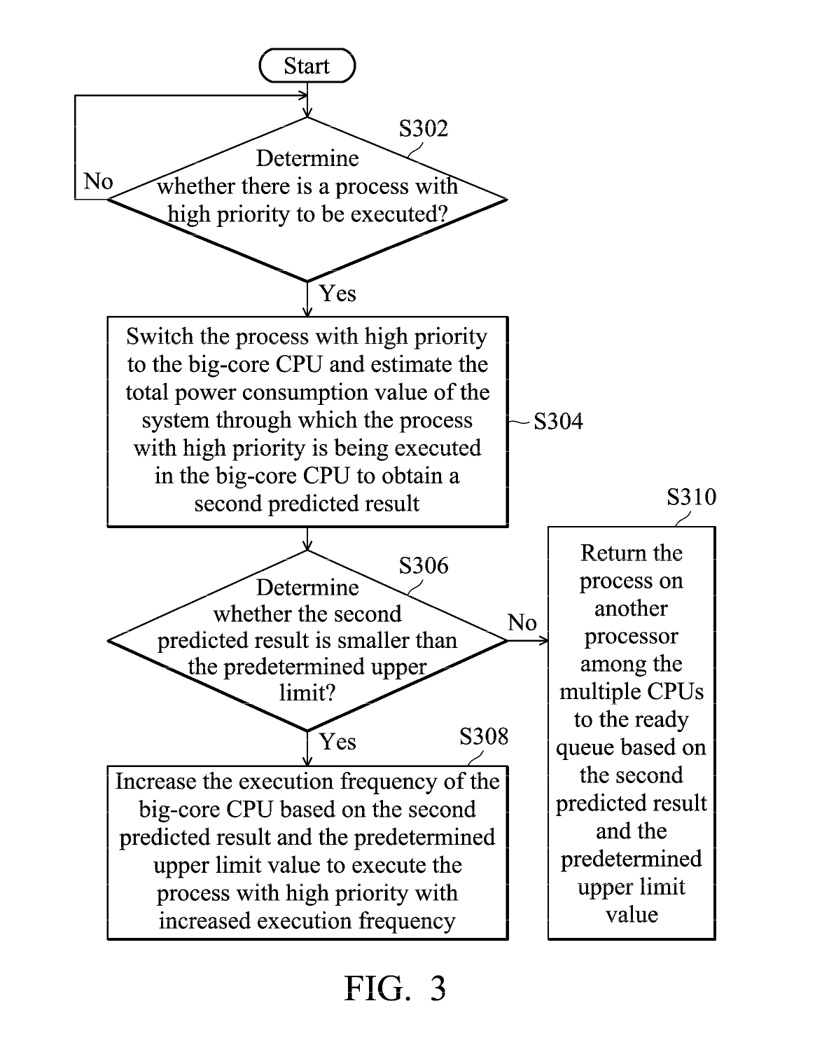

FIG. 3 is a flowchart of another embodiment of a scheduling method of the invention. The scheduling method can be used for an electronic device with multiple processing cores, such as a PDA, a smart phone, a mobile phone, a mobile internet device, a laptop computer, a tablet computer or other similar mobile computing device. For example, the scheduling method can be performed by the scheduling unit 120 of the electronic device 100 shown in FIG. 1 for scheduling processes to be executed in the ready queue. In this embodiment, assuming that the electronic device 100 contains eight processing cores and that four of the processing cores fall under the big core cluster, the remaining four fall under the little core cluster.

First, in step S302, whether there is a process with high priority to be executed is determined. Specifically, this step checks whether processes with high priority or timeliness (e.g. processes communicating with the user) urgently requiring the CPU to complete tasks are present in the ready queue.

If so (Yes in step 302), in step S304, processes with high priority is switched to the big core processor and the total power consumption value of the system through which the process with high priority is being executed in the big-core CPU is estimated to obtain a second predicted result.

Subsequently, in step S306, whether the second predicted result is smaller than the predetermined upper limit value is further determined. When the second predicted result is smaller than the predetermined upper limit value (Yes in step S306), it means the process with high priority switched to the big core processor does not exceed the upper limit of the power consumption value, and there is still power consumption value remaining. Thus, in step S308, based on the second predicted result and the predetermined upper limit value, the execution frequency of the big core processor is increased to execute the process with high priority with increased execution frequency. In other words, based on the differences in the system's power consumption value and the upper limit, the execution frequency of the big core processor can be accordingly increased to shorten the time needed to complete the prioritized process.

Conversely, when the second predicted result is greater or equal to the predetermined upper limit value (No in step S306), it means the process with high priority switched to the big core processor for execution does not exceed the upper limit of power consumption value, in step S310, the process on another processor among the multiple processors is be returned to the ready queue based on the second predicted result and the upper limit value. In other words, the process with high priority switched to the big core processor for execution has exceeded the upper limit of power consumption value. Therefore, less important processes will be chosen from other processors and returned to the ready queue to ensure the prioritized process has sufficient power to consume.

In some embodiments, another mechanism for choosing processes is further provided, which is used to choose the next suitable process in the ready queue for execution.

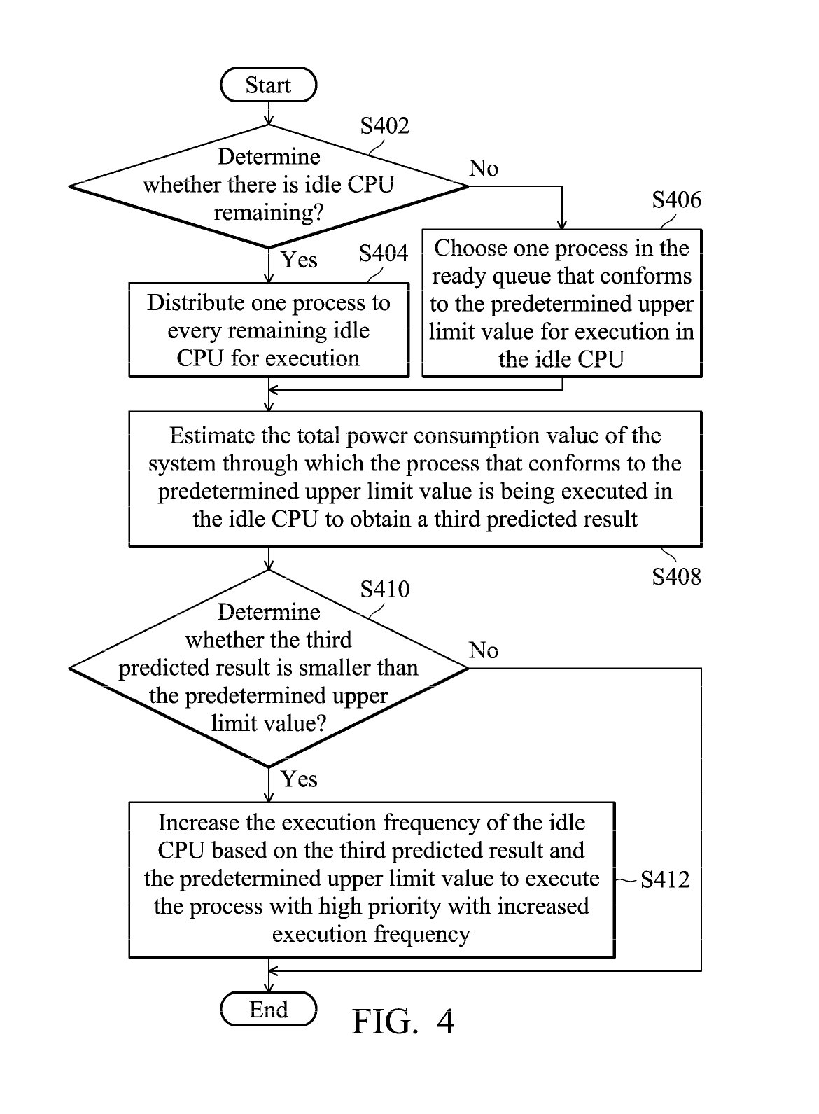

FIG. 4 is a flowchart of another embodiment of a scheduling method of the invention. The scheduling method can be used for an electronic device with multiple processing cores, such as a PDA, a smart phone, a mobile phone, a mobile internet device, a laptop computer, a tablet computer or other similar mobile computing device. For example, the scheduling method can be performed by the scheduling unit 120 of the electronic device 100 shown in FIG. 1 for choosing the next suitable process in the ready queue for execution. In this embodiment, assuming that the electronic device 100 contains eight processing cores and that four of the processing cores fall under the big core cluster, the remaining four fall under the little core cluster.

In step S402, whether there is idle CPU remaining is determined. That is, the idle CPU refers to there is no processes in the processor that require execution or the CPU is placed in the idle state. If so, in step S404, one process is distributed to every remaining idle CPU for execution. For example, assuming the system currently has two idle CPUs, two processes from the ready queue can be distributed to these two idle CPUs for execution. In view of this, all the processors have processes to execute, thus enhancing the system's degree of parallelism and ensuring the system performance.

If it is determined that there is no remaining idle CPU (No in step S402), in step S406, one process in the ready queue that conforms to the predetermined upper limit value will be chosen for execution in the idle CPU. Subsequently, in S408, the total power consumption value of the system through which the process that conforms to the predetermined upper limit value is being executed in the idle CPU is estimated to obtain a third predicted result. Additionally, in step S410, whether the third predicted result is smaller than the predetermined upper limit value is further determined. When the third predicted result is smaller than the predetermined upper limit value (Yes in step S410), it means the system still has usable power consumption. Hence, in step S412, based on the third predicted result and predetermined upper threshold, the execution frequency of the chosen idle CPU is increased, and the process with high priority will be executed with increased execution frequency. In other words, based on the differences in the system's current predetermined power consumption value and upper limit value, the execution frequency of the idle CPU is accordingly increased to enhance execution performance.

In some embodiments, a method for switching between the big core CPU and the little core CPU is further provided to determine whether or not a specific process needs switching in the big core CPU and the little core CPU.

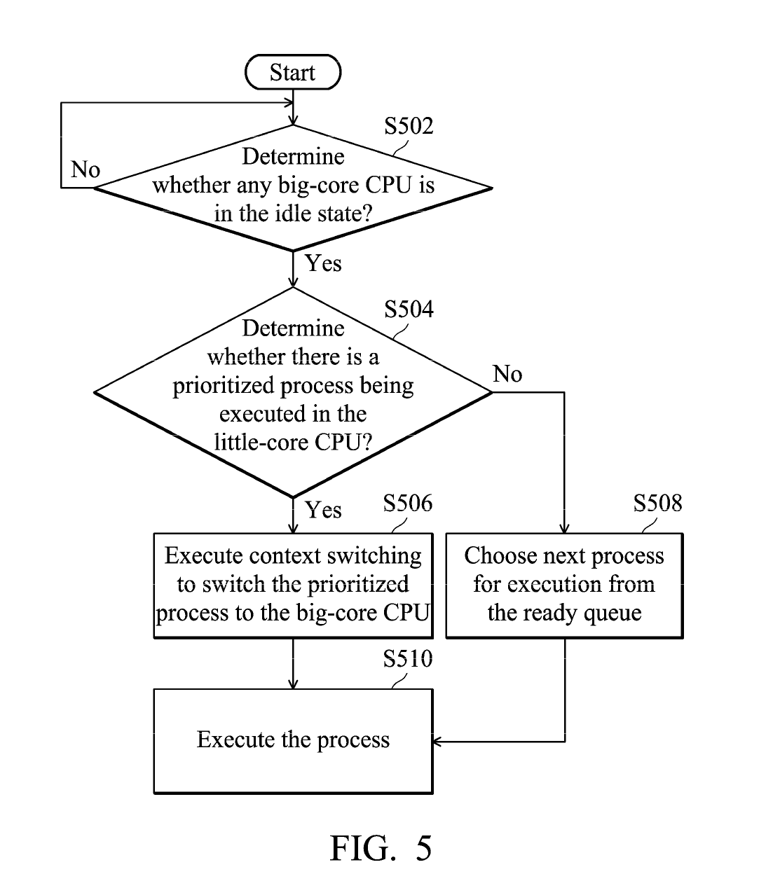

FIG. 5 is a flowchart of another embodiment of a scheduling method of the invention. The scheduling method can be used for an electronic device with multiple processing cores, such as a PDA, a smart phone, a mobile phone, a mobile internet device, a laptop computer, a tablet computer or other similar mobile computing device. For example, the scheduling method can be performed by the scheduling unit 120 of the electronic device 100 shown in FIG. 1 for determining whether a specific process requires switching in the big core CPU and little core CPU. In this embodiment, assuming that the electronic device 100 contains eight processing cores and that four of the processing cores fall under the big core cluster, the remaining four fall under the little core cluster.

First, whether any big core CPU is in the idle state is detected (step S502). Assuming no big core CPU that is in the idle state is detected, step S502 will be repeated. When the big core that is the idle state is detected (Yes in step S502), whether there is a prioritized process being executed in the little core CPU is further determined (step S504). Assuming there is no process with higher priority or timeliness in the little core CPU being executed or requiring execution (No in step S504), a next process is chosen from the ready queue (step S508) and the chosen process is executed (step S510).

Assuming there is one prioritized process in the little core CPU being executed (i.e. A process with higher priority or timeliness is being executed or requires execution) (Yes in step S504), context switching is executed to switch the prioritized process to the big core CPU (step S506) and the switched process is further executed (step S510).

Thus, the big core CPU is only intended for processes with higher priority, rather than allowing arbitrary context switching from the little core CPU to the big core CPU, thus preventing high costs that arise from frequent switching in the big cluster and little cluster.

In some embodiments, when no process in the big core CPU needs to be executed, the CPU may be turned off to increase usable power consumption and increase the execution frequency of the little core CPU, thereby not only saving energy but also increasing the performance of little core CPU.

Therefore, the multi-core processor systems and related scheduling method of the invention can dynamically execute processes switching in different types of core processor clusters to reach higher performance within a designated power consumption value, thus achieving a perfect balance between high performance and lower power consumption value requirement and enhancing the overall performance and further extending the standby time to enhance user satisfaction. Furthermore, the multi-core processor systems and related scheduling method of the invention can first process the processes with high priority or timeliness in the ready queue and adaptively increase the execution frequency of processor, ensure the completion of prioritized processes within the shortest possible time, and increase the system performance within a given power consumption value, thus effectively achieving the purpose of higher performance and low power consumption.

Scheduling methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A scheduling method for a multi-core processor system including a plurality of processors, comprising:
choosing a process to be executed from a ready queue;
analyzing the process to be executed to obtain a power consumption value of the process to be executed;
choosing an idle processor from the plurality of processors and estimating a total power consumption value of system through which the process to be executed is being executed in the idle processor to obtain a first prediction result based on the obtained power consumption value of the process to be executed; and
determining whether to execute the process to be executed in the idle processor according to the first prediction result and a predetermined upper limit value,
wherein the process to be executed is determined to be executed in the idle processor when the first prediction result is smaller than the predetermined upper limit value.

2. The scheduling method of claim 1, wherein the idle processor is a big-core processor and the method further comprises:
determining whether a process with a high priority waits to be executed;
if so, switching the process with the high priority to the big-core processor and estimating a total power consumption value of system when the process with the high priority is being executed in the big-core processor to obtain a second prediction result;
determining whether the second prediction result is smaller than the predetermined upper limit value; and
when the second prediction result is smaller than the predetermined upper limit value, increasing an execution frequency of the big-core processor according to the second prediction result and the predetermined upper limit value.

3. The scheduling method of claim 2, further comprising:
when the second prediction result is greater than or equals to the predetermined upper limit value, returning at least one process in another processor of the plurality of processors to the ready queue according to the second prediction result and the predetermined upper limit value.

4. The scheduling method of claim 1, further comprising:
determining whether any remaining idle processor exists;
when at least one remaining idle processor exists, distributing one of the processes in the ready queue to each of the at least one remaining idle processor for execution; and
when no remaining idle processor exists, selecting a process that conforms to the predetermined upper limit value from the ready queue to be executed in the idle processor.

5. The scheduling method of claim 4, further comprising:
estimating a total power consumption value of system through which the process that conforms to the predetermined upper limit value is being executed by the idle processor to obtain a third prediction result;
determining whether the third prediction result is smaller than the predetermined upper limit value; and
when the third prediction result is smaller than the predetermined upper limit value, increasing an execution frequency of the idle processor according to the third prediction result and the predetermined upper limit value.

6. The scheduling method of claim 1, wherein the plurality of processors further comprise at least a big-core processor and a little-core processor, and the method further comprises:
determining whether the big-core processor is in an idle state;
if so, determining whether a process with a high priority within the little-core processor waits to be executed; and
when a process with the high priority within the little-core processor waits to be executed, switching the process with the high priority to the big-core processor for execution.

7. A multi-core processor system, comprising:
a storage unit;
a plurality of processors; and
a scheduling unit coupled to the storage unit and the plurality of processors, choosing a process to be executed from a ready queue, analyzing the process to be executed to obtain a power consumption value of the process to be executed, choosing an idle processor from the plurality of processors and estimating a total power consumption value of system through which the process to be executed is being executed in the idle processor to obtain a first prediction result based on the obtained power consumption value of the process to be executed, and determining whether to execute the process to be executed in the idle processor according to the first prediction result and a predetermined upper limit value,
wherein the scheduling unit determines that the process to be executed is executed in the idle processor when the first prediction result is smaller than the predetermined upper limit value.

8. The multi-core processor system of claim 7, wherein the idle processor is a big-core processor and the scheduling unit further determines whether a process with a high priority waits to be executed, and if so, switches the process with the high priority to the big-core processor and estimates a total power consumption value of system through which the process with the high priority is being executed in the big-core processor to obtain a second prediction result, determines whether the second prediction result is smaller than the predetermined upper limit value, and when the second prediction result is smaller than the predetermined upper limit value, increases an execution frequency of the big-core processor according to the second prediction result and the predetermined upper limit value.

9. The multi-core processor system of claim 8, wherein the scheduling unit further returns at least one process in another processor of the plurality of processors to the ready queue according to the second prediction result and the predetermined upper limit value when the second prediction result is greater than or equals to the predetermined upper limit value.

10. The multi-core processor system of claim 7, wherein the scheduling unit further determines whether any remaining idle processor exists, and distributes one of the processes in the ready queue to each of the at least one remaining idle processor for execution when at least one remaining idle processor exists and selects a process that conforms to the predetermined upper limit value from the ready queue to be executed in the idle processor when no remaining idle processor exists.

11. The multi-core processor system of claim 10, wherein the scheduling unit further estimates a total power consumption value of system when the process that conforms to the predetermined upper limit value is being executed in the idle processor to obtain a third prediction result, determines whether the third prediction result is smaller than the predetermined upper limit value and increases an execution frequency of the idle processor according to the third prediction result and the predetermined upper limit value when the third prediction result is smaller than the predetermined upper limit value.

12. The multi-core processor system of claim 7, wherein the plurality of processors further comprise at least a big-core processor and a little-core processor, and the scheduling unit further determines whether the big-core processor is in an idle state, if so, determines whether a process with a high priority within the little-core processor waits to be executed and switches the process with the high priority to the big-core processor for execution when a process with the high priority within the little-core processor waits to be executed.
